(19) United States
(12) Patent Application Publication
(10) Pub. No.: US 2025/0341395 A1
(43) Pub. Date: Nov. 6, 2025

(54) SYSTEMS AND METHODS FOR SENSING VELOCITY

(71) Applicant: The Boeing Company, Arlington, VA (US)

(72) Inventors: Travis M. Autry, Calabasas, CA (US); Matthew J. Pelliccione, Santa Monica, CA (US); Danny M. Kim, Agoura Hills, CA (US); Rongsheng Li, Menifee, CA (US); Megan L. Kelleher, Thousand Oaks, CA (US)

(21) Appl. No.: 18/776,081

(22) Filed: Jul. 17, 2024

Related U.S. Application Data
(60) Provisional application No. 63/642,503, filed on May 3, 2024.

(51) Int. Cl. G01C 21/08; G01C 21/16

(52) U.S. Cl. CPC G01C 21/08; G01C 21/166

(57) ABSTRACT

Systems and methods for sensing velocity based on the Lorentz force experienced by a charged object moving in a magnetic field (e.g., Earth's magnetic field) are described. In some examples, methods for sensing velocity may include sensing a displacement of a charged optomechanical resonator disposed in an optical cavity as the optical cavity moves through a magnetic field. A velocity associated with the movement of the optical cavity through the magnetic field is determined based at least on the sensed displacement of the resonator.

### CROSS-REFERENCES

The following applications and materials are incorporated herein, in their entireties, for all purposes: U.S. Provisional Patent Application No. 63/642,503, filed May 3, 2024.

### FIELD

The present disclosure relates to systems and methods for sensing velocity based on Lorentz force.

### BACKGROUND

Many navigational systems rely on the Global Positioning System (GPS) and/or one or more other global navigation satellite systems (GNSS) to detect position. When such a navigational system is unable to rely on GPS for position detection (e.g., in an urban canyon or other environment where the satellite signals cannot reliably be received), position must be inferred from other sensed quantities, such as directional heading and velocity. However, known methods of determining position based on a sensed velocity suffer various drawbacks. Sensing velocity necessarily entails measuring the velocity of the sensor platform relative to a reference, such as another object or part of the environment, and this referential measurement can be affected by noise or other issues external to the sensor platform. Additionally, it is often difficult or impossible to decouple the velocity of the sensor platform from environmental factors, such as wind or water flow. Accordingly, better solutions are needed for sensing velocity.

### SUMMARY

The present disclosure provides systems, apparatuses, and methods relating to sensing velocity.

In some examples, a method for sensing velocity may comprise sensing a displacement of a charged optomechanical resonator disposed in an optical cavity as the optical cavity moves through a magnetic field; and determining, based on one or more factors including at least the sensed displacement of the charged optomechanical resonator, a velocity associated with the movement of the optical cavity through the magnetic field.

In some examples, a system for sensing velocity may comprise an optical cavity comprising an optomechanical resonator, the optomechanical resonator having an electrical charge; an optical measurement system configured to sense optical output of the cavity; and processing logic in communication with the optical measurement system, wherein the processing logic is configured to determine, based on the sensed optical output of the cavity, a displacement of the optomechanical resonator by a magnetic field through which the optical cavity is traveling.

In some examples, a system for sensing velocity may comprise a Lorentz force sensor comprising a charged object, wherein the Lorentz force sensor is configured to sense a Lorentz force experienced by the charged object; a magnetometer configured to sense a magnetic field at a present location of the Lorentz force sensor; and processing logic configured to determine, based on the sensed Lorentz force and the sensed magnetic field, a velocity of the charged object through the magnetic field.

### BRIEF DESCRIPTION OF THE DRAWINGS

FIG. 1 is a schematic diagram depicting an illustrative velocity-sensing system in accordance with aspects of the present teachings.

FIG. 2 is an exploded isometric view of an illustrative optical cavity suitable for use in a velocity-sensing system in accordance with aspects of the present teachings.

FIG. 3 is a front view of an illustrative optomechanical membrane suitable for use in the cavity of FIG. 2.

FIG. 4 is an exploded side view of another illustrative optical cavity suitable for use in a velocity-sensing system in accordance with aspects of the present teachings.

FIG. 5 is a schematic view depicting an illustrative three-axis assembly of optical cavities suitable for use in a velocity-sensing system in accordance with aspects of the present teachings.

FIG. 6 is a schematic diagram depicting an illustrative force-sensing system in accordance with aspects of the present teachings, including an optical cavity assembly having a charged membrane, a laser system configured to interrogate the cavity, and a detection system configured to measure the cavity output.

FIG. 7 is a flow chart depicting steps of an illustrative method for sensing velocity in accordance with aspects of the present teachings.

### DESCRIPTION

In general, a velocity-sensing system in accordance with aspects of the present teachings is configured to measure the Lorentz force experienced by a charged object based on its movement through Earth's magnetic field. The Lorentz force experienced by the charged object is the charge of the object multiplied by the vector cross product of the velocity of the object and the magnetic field through which it is moving:

$$\vec{F} = q \vec{v} \times \vec{B} \qquad ( Equation 1 )$$

Accordingly, when the force, magnetic field, and charge have been measured (or otherwise have become known), the velocity of the object can be calculated. Systems and methods described herein are configured to measure Lorentz force with high sensitivity, such that force measurements can be made even in the Earth's relatively small magnetic field and even when the velocity of the object in question is low.

In some examples, a velocity-sensing system in accordance with aspects of the present teachings includes a charged optomechanical object disposed in an optical cavity, such that at least one property of the cavity is affected by motion imparted to the charged optomechanical object by the Lorentz force as the cavity moves through a magnetic field (e.g., as a platform on which the cavity is mounted moves through the magnetic field). The effect on the cavity property is detected by interrogating the cavity with a laser, such that the effect can be determined based on the laser output of the cavity. Using the determined effect on the cavity property, the Lorentz force experienced by the charged object is measured or calculated. The measured or calculated Lorentz force, together with the magnetic field and the charge of the charged object, is used to calculate the velocity of the charged object, and thus the velocity of the cavity and any platform carrying the cavity.

In some examples, the angle between the direction of travel of the cavity (e.g., the heading of a platform carrying the cavity) and the magnetic field vector is used to help calculate the velocity, and/or to confirm a calculated velocity. Cross-products, such as the cross-product between velocity and magnetic field in Equation 1, can be ambiguous with respect to the angle between the two input vectors. Knowledge of the angle between heading and magnetic field vector can help to resolve the ambiguity, so that any impact of the ambiguity on the velocity calculation can be avoided and/or corrected. The heading may be measured by a co-sensor and/or obtained in any other suitable manner.

The magnetic field and the charge of the charged object can each be determined in any suitable way. For example, the charge of the charged object may be measured directly or indirectly, inferred from a voltage applied to the object, and/or determined in any other suitable way. The magnetic field at (or approximately at) the charged object may be measured by a vector magnetometer disposed near the cavity, and/or by any other suitable device.

The magnetic field sensed by the magnetometer may include not just the Earth's magnetic field, but also any additional magnetic field components that are present (e.g., associated with an object external to the velocity-sensing system). This may allow the impact of any additional magnetic field on the charged object in the optical cavity to be at least partially accounted for, such that the presence of additional magnetic fields does not prevent the velocity-sensing system from functioning.

As can be understood from Equation 1, no Lorentz force acts on an object moving parallel to the direction of the magnetic field, and so the system described above is unable to measure velocity when the charged object is moving parallel to the Earth's magnetic field. In many use cases, this situation arises infrequently. For example, the Earth's magnetic field has a significant component that is vertical (i.e., pointing toward or away from the center of the Earth) over much of the planet, and so a sensor platform moving in a generally horizontal direction will usually not be moving entirely parallel to the Earth's magnetic field. Even in a situation where the trajectory of the sensor platform is parallel to the Earth's magnetic field, such as if the sensor platform is on a vehicle that is expected to travel such a trajectory, the vehicle can be steered along in a weaving or tacking motion so that its velocity has a component nonparallel to the Earth's magnetic field.

Illustrative, non-limiting examples of velocity-sensing systems and methods, and aspects and components thereof, are described below.

### Example Velocity-Sensing System

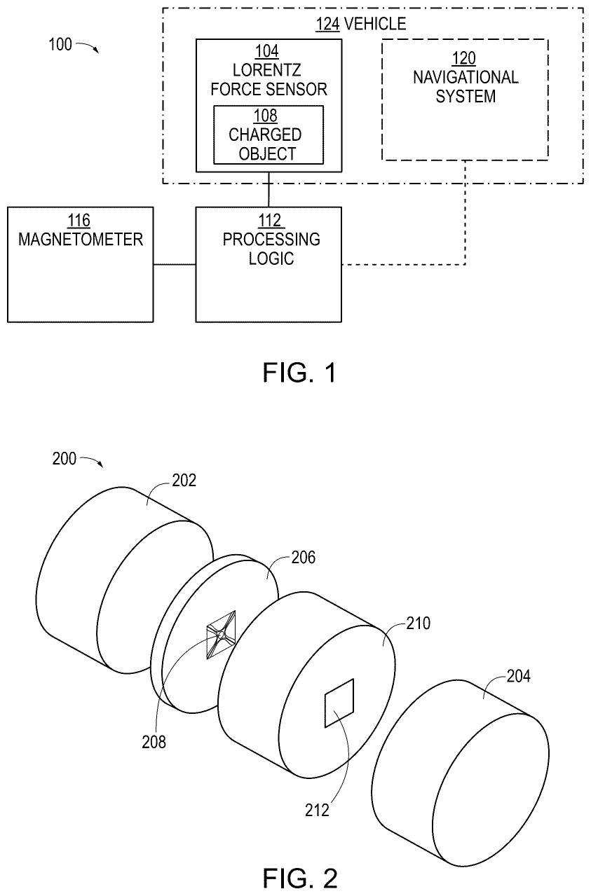

FIG. 1 is a schematic diagram depicting an illustrative velocity-sensing system 100 in accordance with aspects of the present teachings. System 100 includes a Lorentz force sensor 104 comprising at least one charged object 108, which experiences a Lorentz force as it moves through a magnetic field (e.g., the Earth's magnetic field). Examples of Lorentz force sensor 104 and example components thereof are described below.

System 100 further includes processing logic 112, which is in communication with Lorentz force sensor 104. Processing logic 112 may comprise any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, neural networks, digital signal processors (DSPs), and/or any other suitable combination of logic hardware. Processing logic 112 is configured to receive from Lorentz force sensor 104 sensed data reflecting the Lorentz force experienced by charged object 108 of sensor 104.

System 100 further includes a magnetometer 116, which may comprise any suitable device configured to measure the vector magnetic field at or in the vicinity of Lorentz force sensor 104. Processing logic 112 is in communication with magnetometer 116, such that the processing logic receives from the magnetometer data reflecting the sensed magnetic field.

In some examples, processing logic 112 also receives data reflecting the charge of charged object 108 from force sensor 104. Alternatively, or additionally, processing logic 112 may receive the charge information in another way.

Processing logic 112 is further configured to determine the velocity of charged object 108 based on the data reflecting the Lorentz force experienced by the charged object, the data reflecting the sensed magnetic field, and the data reflecting the charge of the charged object. The velocity of Lorentz force sensor 104 may be assumed to be the velocity of charged object 108, or in some examples may be calculated (e.g., by processing logic 112) based on the velocity of charged object 108. Accordingly, processing logic 112 can be described as being configured to determine the velocity of Lorentz force sensor 104.

Optionally, Lorentz force sensor 104 and one or both of processing logic 112 and magnetometer 116 are contained in a common housing and/or mounted to a same platform (not shown).

Optionally, processing logic 112 is in communication with a navigational system 120 of a vehicle 124 on which Lorentz force sensor 104 is disposed. Navigational system 120 may use the velocity of Lorentz force sensor 104 to navigate vehicle 124, e.g., by using the velocity together with information about the bearing of the vehicle to determine the vehicle's position. Navigational system 120 may receive velocity data from processing logic 112 continuously, in real time or near real time, at predetermined intervals, on demand, or on any other suitable basis. In some examples, processing logic 112 is part of navigational system 120.

Vehicle navigation is an illustrative, non-limiting example use of system 100; in general, system 100 can be used in any application in which velocity measurements are desired.

### Example Cavity Assemblies

FIG. 2 is an exploded isometric view depicting an illustrative cavity assembly 200 in accordance with aspects of the present teachings. Assembly 200 is an example of an optical cavity suitable for use in Lorentz force sensor 104, described above.

Assembly 200 comprises an optical cavity defined between a pair of mirrors 202, 204. A plate 206 supporting a charged optomechanical device 208 is disposed in the cavity, between the two mirrors. A laser (not shown) is coupled into the cavity at one end, and the output from the opposing end is measured to obtain data usable to determine the velocity of the cavity (or a platform including the cavity). Any suitable laser may be used. A narrow linewidth laser may be desirable to facilitate high-precision measurements. In some examples, commercially available lasers having a wavelength of 1064 nanometers have suitably narrow linewidths to facilitate the desired measurements.

A spacer 210 is disposed between the plate and one of the cavity mirrors; this spacer is optional and may be omitted, or may have a different size. More generally, any suitable number of spacers of any suitable thicknesses may optionally be disposed between the plate and either or both end mirrors of the cavity. The spacer(s) between the plate and a given one of the mirrors is configured to space the plate from the mirror by a desired distance while still allowing a laser coupled to the cavity to pass through the spacer; for example, the spacer may have an aperture in the center, or may have a material at the center that is transparent to light of the laser's wavelength. In the depicted example, spacer 210 has a central aperture 212 through which laser light can pass. In general, the spacer(s) are selected to give the cavity a desired length, which may in turn determine the cavity's finesse, suitability for use with a given laser, and/or any other suitable factor(s).

FIG. 2 is an exploded view; in reality, the mirrors, plate, and any spacers are attached to each other by adhesive and/or in any other suitable manner. The shapes of the mirrors, spacer, and plate depicted in FIG. 2 are illustrative; in general, any suitable geometry may be used.

The charged optomechanical device may comprise any suitable optomechanical device, and the plate may comprise any suitable structure(s) configured to support the optomechanical device in the cavity. The thickness of the plate itself may be selected to help yield a desired cavity length.

In the depicted example, the optomechanical device comprises a capacitively charged membrane. As the membrane moves through Earth's magnetic field, the Lorentz force displaces the membrane by a small amount within the cavity, which changes the optical frequency of the cavity. Example optomechanical membranes are described below.

The optical cavity may be a Fabry-Perot optical cavity and/or any other suitable cavity. Properties of the cavity, such as quality factor (Q), cavity size, supported wavelength, and stability, are in some examples selected to facilitate sensitive velocity measurements based on membrane displacement. The material(s) making up the mirrors, spacer(s), membrane, plate, and any other components may be selected to facilitate passive stabilization of the cavity length. For example, materials such as ultra-low expansion glass, fused silica, and/or silicon with low coefficient of thermal expansion may be used.

The mirrors of the cavity can be any diameter from 0.5 mm-10 cm. The mirror faces can be curved or flat. Any suitable curvature can be used; in some examples, a very small radius of curvature (e.g., 2 millimeters) results in a suitably high optomechanical sensitivity. The distance between the mirrors can be adjusted by adding spacers, as described above. The spacer lengths can be in the range of 100 microns-1 m. In some examples, a total cavity length of several millimeters (e.g., 2 millimeters) and a mirror diameter of several millimeters (e.g., 3 millimeters) achieves a desired cavity finesse and stability.

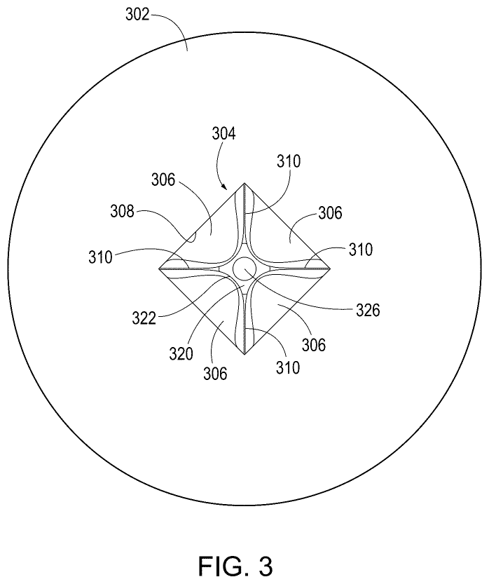

An illustrative example plate 302 and capacitively charged membrane 304 are depicted in front view in FIG. 3. Plate 302 and membrane 304 are, respectively, examples of plate 206 and optomechanical device 208 of FIG. 2, described above. Plate 302 has an opening 308 in a central portion of the plate, and membrane 304 is disposed in opening 308. A plurality of electrodes 306, described below, are disposed adjacent membrane 304. In the depicted example, opening 308 is square-shaped and four arms 310 of membrane 304 are connected to respective corners of the square opening. In other examples, the opening may be of a non-square shape, e.g., a circle, a rectangle, an oval, or any other suitable shape. Arms 310 of membrane 304 suspend the body of the membrane in the center of the plate. In general, any suitable geometry may be used that allows the membrane to be supported by the plate, displaced by Lorentz force, and capacitively charged as described next.

A plurality of ground electrodes 306 are disposed in opening 308. The depicted example includes four electrodes 306, but in other examples, any other suitable number of electrodes may be included. A portion 320 of membrane 304 is coated in metal, including edge portions 322 of the membrane, and the coated edge portions 322 of the membrane are spaced from the nearest electrode 306 by a gap. This arrangement comprises a capacitor, allowing the membrane to be capacitively charged. A central portion 326 of the membrane body is uncoated, and the central material of the membrane is selected to be optically transparent to the laser, such that the laser beam passes through the central portion of the membrane with low loss.

The thickness of membrane 304 may be very thin compared to the wavelength of light coupled into the cavity; in some examples, the thickness of the membrane is 50-500 nanometers, or 10s of nanometers (e.g., approximately 10-100 nanometers). The membrane mass may be 1-1000 nanograms; the small mass of the membrane allows it to be detectably displaced by the Lorentz force associated with the Earth's magnetic field.

Membrane 304 may comprise any suitable material(s) that is optically transparent to the laser used. Examples of suitable materials may include silicon, silicon nitride, alumina, quartz, and silicon dioxide. The metal coating of portion 320 of the membrane may include any suitable metal(s), and in some examples includes gold. The membrane may have a resonant frequency in the MHz range (e.g., generally in the range of 10 kHz-10 MHz), though a membrane with any suitable resonant frequency may be used. In general, it is desirable to impart a high charge to the membrane, because the Lorentz force is proportional to the amount of charge, and therefore a greater charge leads to a greater, more easily detected, force.

If the membrane is disposed exactly at a node of the cavity, where the laser's field amplitude is zero, the membrane will be unable to affect the laser output of the cavity. Accordingly, in some examples, a mechanism is provided for adjusting the position of the membrane within the cavity so that the membrane can be moved away from a node if needed. The mechanism may comprise an actuator (e.g., a piezoelectric actuator) configured to adjust the position of the membrane and/or plate. In some examples, an electric field at the membrane is adjusted to deflect the membrane, without necessarily adjusting the plate. Only a small adjustment (less than half a wavelength of the laser) is needed to avoid a node.

The capacitor comprising the membrane may be a fringing field capacitor, which tends to reduce the possible impact of perpendicular electric fields on the membrane.

In the depicted example, membrane 304 is a trampoline resonator; in general, any suitable resonator may be used. As another example, an optomechanical device may comprise a charged membrane pivotably attached to a frame, such that the Lorentz force causes the membrane to pivot about its pivotable connection to the frame. The pivoting membrane may deflect the laser beam in the cavity, resulting in interference patterns from which the cavity's velocity can be determined.

Generally speaking, the response of membrane 304 (or another suitable membrane) to the Lorentz force is similar to that of a spring, such that the displacement of the membrane is proportional to the force applied. When the cavity moves with finite velocity, the membrane is subject to the Lorentz force and this displacement is read out as a change in the cavity frequency or phase. The displacement caused by the Lorentz force is described by the following equation:

$$\vec{x} = \frac{CU \vec{V} \times \vec{B}}{2 m ω} \frac{1}{δ - \frac{i γ}{2}} \qquad Equation 2$$

where C is the capacitance of the capacitor, U is the voltage applied to the membrane, δ is the detuning with respect to the membrane's mechanical resonance, γ is the full-width half-max linewidth of the membrane's mechanical resonance, and ω is the membrane frequency.

The membrane displacement shifts the cavity frequency and thus causes a frequency shift in a laser that is locked to the optical cavity. When the velocity of the cavity through the magnetic field is changing in time, the frequency modulation on the laser is time-dependent, as is the membrane displacement. The time-dependent frequency shift of the cavity, and the laser locked to the cavity, can be determined using the following model for the cavity resonance frequency:

$${ω}_{c} ( t ) = {ω}_{c}^{0} + \frac{d {ω}_{c}}{dx} x ( t ) \qquad Equation 3$$

where ω_{c} is the cavity resonance frequency, ω_{c}⁰ is the cavity resonance frequency at zero velocity, and dω_{c}/dx is the change in cavity frequency per unit displacement of the membrane.

In some examples, the charge on the membrane is modulated (e.g., by modulating voltage U) at the frequency of the first mechanical resonance of the membrane, so as to separate the charge-dependent Lorentz force response in the frequency domain from charge-independent forces associated with environmental factors. Modulating the membrane charge in this manner can improve device sensitivity significantly, to the point that the sensitivity is set by the thermal noise motion of the mechanical membrane, capacitive noise, and the amount of charge on the membrane, rather than by environmental factors.

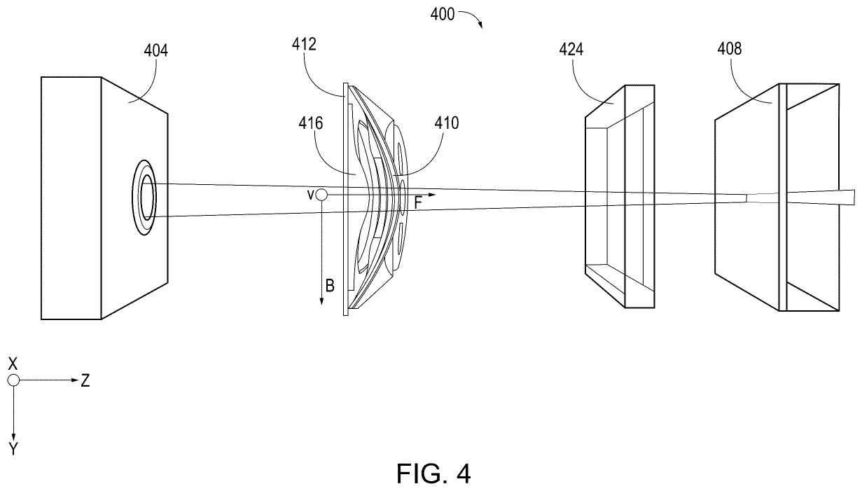

FIG. 4 is an exploded side view depicting another illustrative cavity assembly 400 in accordance with aspects of the present teachings. Assembly 400 is similar in many respects to assembly 200, and the description of FIG. 4 is therefore abbreviated accordingly. The components depicted in FIG. 4 are not necessarily to scale.

Assembly 400 comprises an optical cavity defined by two high-finesse mirrors, specifically, a curved mirror 404 at a first end of the cavity and a flat mirror 408 at a second end of the cavity. Each mirror is coated in a high-reflectivity distributed Bragg reflector coating; in other examples, a different coating(s) or no coating may be used. An optomechanical membrane 410 comprising Si₃N₄ is supported by a silicon frame 412. The edge portions of the membrane are coated in metal, and the frame further supports metal ground electrodes 416 that form a capacitor with the coated edge portions of the membrane. The center of membrane 410 is free of coating so that it remains optically transparent to the laser. A glass spacer 424 between flat mirror 408 and frame 412 adds to the cavity length. If shown in a non-exploded view, the components would be sandwiched together, with curved mirror 404 abutting membrane frame 412, the membrane frame abutting spacer 424, and the spacer abutting flat mirror 408.

As illustrated by the vectors shown in FIG. 4, assembly 400 is moving with a vector velocity v that has a nonzero component in the X direction, and the magnetic field B at the location of the assembly has a nonzero component in the Y direction. Accordingly, the membrane experiences a Lorentz force F having a nonzero component in the Z direction, which is generally orthogonal to the surface of membrane 410. Membrane 410 is therefore displaced in the Z direction by the Z-component of the Lorentz force, and so the Z-component of the Lorentz force can be detected using assembly 400. However, if X- or Y-components of the Lorentz force also exist (i.e., if the velocity and/or magnetic field has a nonzero component in the Z direction), displacement of the membrane in the Z direction will not be affected by those components, and so the assembly will not detect those components.

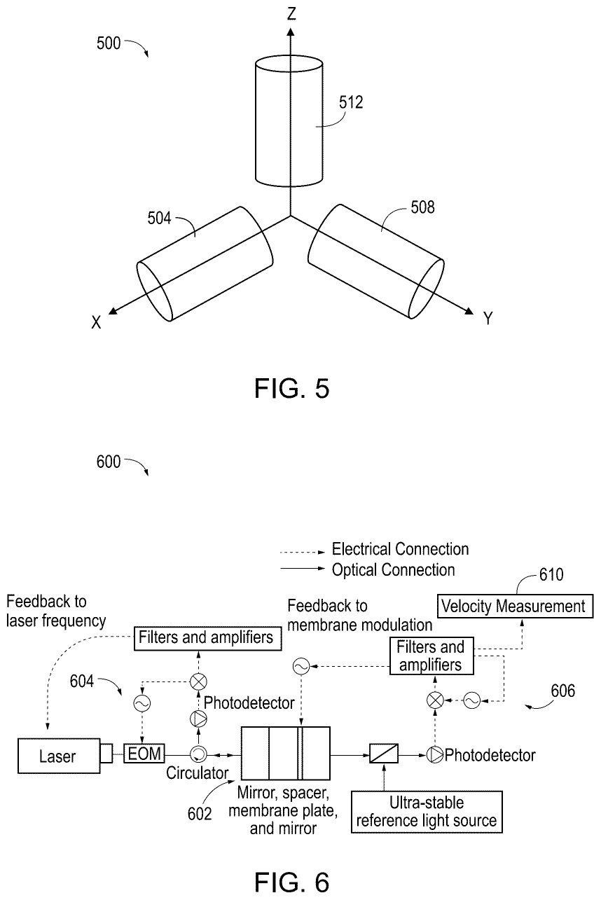

Accordingly, in some examples, a plurality of cavity assemblies, each oriented in a different direction, are used. FIG. 5 is a schematic isometric view depicting an illustrative three-axis cavity assembly 500 in accordance with aspects of the present teachings. Three-axis assembly 500 includes three single-axis cavity assemblies 504, 508, 512, each of which may be an example of cavity assembly 200, cavity assembly 400, and/or any other suitable cavity assembly. Assemblies 504, 508, 512 are all oriented orthogonal to each other (e.g., along a set of Cartesian axes, as shown in FIG. 5). Using three orthogonal axes allows all three components of the velocity of assembly 500 to be measured.

In some examples, more than three assemblies are used for redundancy. In some examples, one or more cavities that lack a charged resonator are also included. The output of the cavities that have a charged membrane or other charged resonator can be compared to the output of those without a charged resonator to correct for noise sources common to both types of cavities, such as high-frequency vibrations and/or susceptibility to large-amplitude, low-frequency vibrations.

### Example Force-Sensing System

FIG. 6 is a schematic diagram depicting an illustrative force-sensing system 600. System 600 includes a cavity assembly 602, a laser system 604 configured to interrogate the cavity assembly, and a detection system 606 configured to measure the cavity output to sense data reflecting the Lorentz force acting on the cavity membrane. System 600 further includes processing logic 610 configured to determine a velocity of the cavity based on the data sensed by detection system 606. Cavity assembly 602 may be similar or identical to assembly 200 or assembly 400 described above, and/or may be any other suitable optical cavity assembly.

In the example depicted in FIG. 6, laser system 604 includes a narrow linewidth laser that is sent through a circulator toward cavity assembly 602. Light returning from the cavity is sent to a photodetector of laser system 604. The signal from this photodetector is processed and used for feedback to the frequency of the laser to lock the laser to the cavity.

The transmitted laser light from the other end of the cavity is combined with light from an ultra-stable reference light source of detection system 606, and the beat note between the transmitted light and the reference light is detected by detection system 606 using heterodyne detection. Frequency shifts in the beat note signal can be used (e.g., by processing logic 610) to determine the velocity at which the system is moving through a magnetic field, based on the relationship between the frequency of the cavity (to which the input laser is locked) and displacement of the membrane.

The beat note signal is also used for feedback to the high voltage driver for the capacitor formed by the membrane and accompanying electrodes. This keeps the driving frequency of the capacitor matched to the mechanical resonance of the membrane. The amplitude of the membrane's mechanical resonance is proportional to the velocity. The information from this signal is combined with a real-time measurement of the magnetic field, and information about the charge on the capacitor, and converted into a velocity measurement by processing logic 610.

As shown in FIG. 6, the beat note signal may be processed (e.g., filtered, amplified, and/or the like) before being used for feedback to the capacitor driver and/or before being used for frequency shift detection.

The reference light source used to enable heterodyne detection may be any suitable light source. In some examples, the reference light source comprises a low-noise laser stabilized to a conventional Fabry-Perot cavity (i.e., a Fabry-Perot cavity having no charged optomechanical components configured for Lorentz force detection).

### Example Method for Sensing Velocity

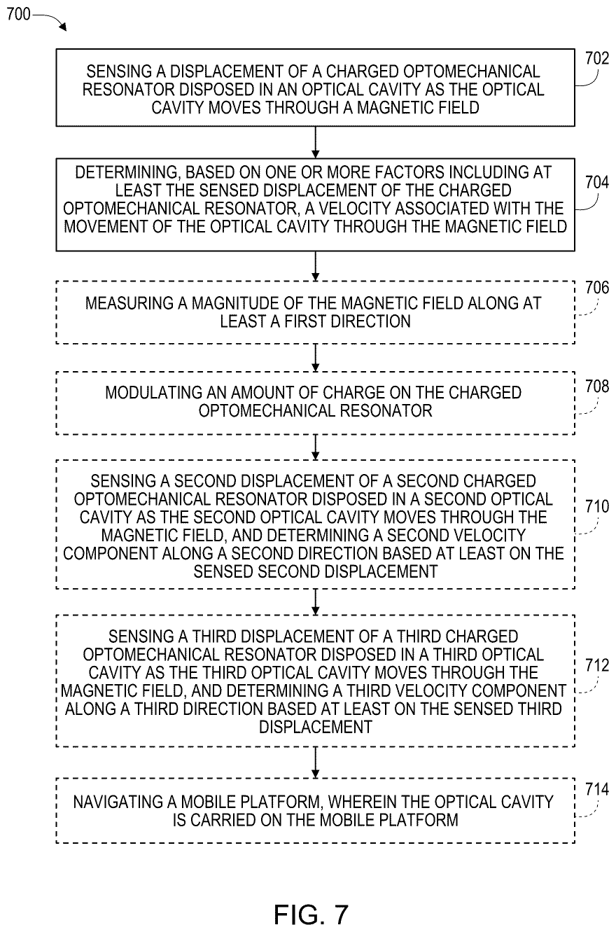

FIG. 7 is a flowchart depicting illustrative steps in an illustrative method 700 for sensing velocity in accordance with aspects of the present teachings. In FIG. 7, some steps are illustrated in dashed boxes indicating that such steps may be optional or may correspond to an optional version of a method according to the present teachings. That said, not all methods according to aspects of the present teachings are required to include the steps illustrated in solid boxes. The method and steps illustrated in FIG. 7 are not limiting and other methods and steps are within the scope of the present disclosure, including methods having greater than or fewer than the number of steps illustrated, as understood from the descriptions herein.

At step 702, method 700 includes sensing a displacement of a charged optomechanical resonator disposed in an optical cavity as the optical cavity moves through a magnetic field, such as the Earth's magnetic field. Because the optomechanical resonator is charged, it experiences a Lorentz force as it moves through the magnetic field. In some examples, sensing the displacement of the charged optomechanical resonator comprises interrogating the optical cavity using a laser and detecting an output of the cavity. In some such examples, detecting the cavity output comprises detecting a beat note between light transmitted by the cavity and light obtained from a reference light source, such as a stabilized laser.

At step 704, method 700 includes determining a velocity associated with the movement of the optical cavity through the magnetic field, based on one or more factors including at least the sensed displacement of the charged optomechanical resonator.

At step 706, method 700 optionally includes measuring a magnitude of the magnetic field along at least one direction. In examples in which step 706 is performed, the one or more factors of step 704 optionally further include the measured magnitude of the magnetic field.

At step 708, method 700 optionally includes modulating an amount of charge on the charged optomechanical resonator, such that a frequency-domain response of the charged optomechanical resonator to the magnetic field is separate in the frequency domain from a frequency-domain response of the charged optomechanical resonator to any charge-independent forces. In some examples, the charged optomechanical resonator comprises an electrode of a capacitor, and modulating the amount of charge comprises modulating a voltage of the capacitor of which the resonator is an electrode.

At step 710, method 700 optionally includes sensing a second displacement of a second charged optomechanical resonator disposed in a second optical cavity, as the second optical cavity moves through the magnetic field. Optional step 710 further includes determining a second velocity component along a second direction based at least on the sensed second displacement. The first and second optical cavities are oriented in different directions, such that the displacements of the first and second optomechanical resonators are in non-parallel directions. For example, the first and second optical cavities may be oriented orthogonally to one another.

At step 712, method 700 optionally includes sensing a third displacement of a third charged optomechanical resonator disposed in a third optical cavity, as the third optical cavity moves through the magnetic field. Optional step 712 further includes determining a third velocity component along a third direction based at least on the sensed third displacement. In some examples in which steps 710 and 712 are performed, the first, second, and third optical cavities are oriented orthogonally to one another, such that the first, second, and third resonators are displaced along orthogonal directions. This may allow the three-cavity assembly to measure the three vector components of a three-dimensional velocity vector.

At step 714, method 700 optionally includes navigating a mobile platform on which the optical cavity is carried. Navigating the mobile platform may comprise estimating a location of the mobile platform based at least on the determined velocity, a direction of movement of the mobile platform, a previous known location of the mobile platform at a previous point in time, and an amount of time elapsed since the previous point in time. In examples in which steps 710 and 712 are performed, all three optical cavities are carried on the mobile platform. Examples of mobile platforms may include automobiles or other vehicles, human-powered vehicles such as bicycles, and/or any other suitable platforms.

### Illustrative Enumerated Paragraphs

The following paragraphs describe illustrative, non-limiting examples of systems and methods described herein:

A0. A method, comprising:
sensing displacement of a charged optomechanical resonator disposed in an optical cavity.

A1. The method of A0, further comprising:
determining, based on the sensed displacement of the charged optomechanical resonator, a velocity component associated with movement of the optical cavity through a magnetic field.

B0. A method for sensing velocity, the method comprising any method step described herein, in any order, using any modality.

C0. A system comprising any feature described herein, either individually or in combination with any other such feature, in any configuration.

D0. A method for sensing velocity, the method comprising:
sensing a displacement of a charged optomechanical resonator disposed in an optical cavity as the optical cavity moves through a magnetic field; and
determining, based on one or more factors including at least the sensed displacement of the charged optomechanical resonator, a velocity associated with the movement of the optical cavity through the magnetic field.

D1. The method of paragraph DO, wherein sensing the displacement of the charged optomechanical resonator comprises interrogating the optical cavity using a laser and detecting an output of the cavity.

D2. The method of paragraph D1, wherein detecting the output of the cavity comprises detecting a beat note between light transmitted by the cavity and light obtained from a reference light source.

D3. The method of any one of paragraphs D0-D2, wherein sensing the displacement comprises sensing a resonance frequency of the cavity and calculating the displacement based at least in part on the sensed resonance frequency.

D4. The method of any one of paragraphs D0-D3, further comprising measuring a magnitude of the magnetic field along at least a first direction, wherein the one or more factors further include the measured magnitude of the magnetic field.

D5. The method of any one of paragraphs D0-D4, further comprising modulating an amount of charge on the charged optomechanical resonator, such that a frequency-domain response of the charged optomechanical resonator to the magnetic field is separate in the frequency domain from a frequency-domain response of the charged optomechanical resonator to any charge-independent forces.

D6. The method of paragraph D5, wherein the charged optomechanical resonator comprises a first electrode of a capacitor, and wherein modulating the amount of charge on the charged optomechanical resonator comprises modulating a voltage of the capacitor.

D7. The method of any one of paragraphs D0-D6, wherein the charged optomechanical resonator is a first charged optomechanical resonator, the optical cavity is a first optical cavity, and the velocity is a first velocity component along a first direction, the method further comprising:
sensing a second displacement of a second charged optomechanical resonator disposed in a second optical cavity as the second optical cavity moves through the magnetic field, and determining a second velocity component along a second direction based at least on the sensed second displacement; and
sensing a third displacement of a third charged optomechanical resonator disposed in a third optical cavity as the third optical cavity moves through the magnetic field, and determining a third velocity component along a third direction based at least on the sensed third displacement.

D8. The method of any one of paragraphs D0-D7, further comprising navigating a mobile platform, wherein the optical cavity is carried on the mobile platform, and wherein navigating the mobile platform comprises:
estimating a location of the mobile platform based at least on the determined velocity, a direction of movement of the mobile platform, a previous known location of the mobile platform at a previous point in time, and an amount of time elapsed since the previous point in time.

E0. A system for sensing velocity, the system comprising:
an optical cavity comprising an optomechanical resonator, the optomechanical resonator having an electrical charge;
an optical measurement system configured to sense optical output of the cavity; and
processing logic in communication with the optical measurement system, wherein the processing logic is configured to determine, based on the sensed optical output of the cavity, a displacement of the optomechanical resonator by a magnetic field through which the optical cavity is traveling.

E1. The system of paragraph E0, wherein the optomechanical resonator comprises a membrane.

E2. The system of paragraph E1, wherein the membrane comprises a trampoline resonator.

E3. The system of any one of paragraphs E0-E2, wherein the optical cavity comprises a Fabry-Perot cavity.

E4. The system of any one of paragraphs E0-E3, wherein the optical measurement system comprises a laser locked to the optical cavity and a detection system configured to sense a frequency shift in the optical output of the cavity, and wherein the processing logic is configured to determine the displacement of the optomechanical resonator based on the sensed frequency shift.

E5. The system of any one of paragraphs E0-E4, wherein the optical cavity is a first optical cavity and the optomechanical resonator is a first optomechanical resonator, the system further comprising:
a second optical cavity comprising a second optomechanical resonator; and
a third optical cavity comprising a third optomechanical resonator;
wherein the first, second, and third optical cavities are oriented orthogonally to one another.

F0. A system for sensing velocity, the system comprising:
a Lorentz force sensor comprising a charged object, wherein the Lorentz force sensor is configured to sense a Lorentz force experienced by the charged object;
a magnetometer configured to sense a magnetic field at a present location of the Lorentz force sensor; and
processing logic configured to determine, based on the sensed Lorentz force and the sensed magnetic field, a velocity of the charged object through the magnetic field.

F1. The system of paragraph F0, wherein the Lorentz force sensor comprises a pair of mirrors defining an optical cavity, the optical cavity having a cavity frequency, and wherein the charged object comprises a charged optomechanical resonator disposed between the pair of mirrors.

F2. The system of paragraph F1, wherein the processing logic is configured to determine the velocity of the charged object through the magnetic field based on a shift in the cavity frequency.

F3. The system of any one of paragraphs F1-F2, wherein the charged optomechanical resonator comprises a membrane.

F4. The system of paragraph F3, wherein the membrane comprises a body portion and a peripheral portion, the peripheral portion is coated in metal and forms a first electrode of a capacitor, and a second electrode of the capacitor is disposed adjacent the membrane.

### CONCLUSION

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required for all apparatuses and methods according to the present disclosure, and the present disclosure contemplates all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A method for sensing velocity, the method comprising:
sensing a displacement of a charged optomechanical resonator disposed in an optical cavity as the optical cavity moves through a magnetic field; and
determining a velocity associated with movement of the optical cavity through the magnetic field, based on one or more factors including at least the sensed displacement of the charged optomechanical resonator.

2. The method of claim 1, wherein sensing the displacement of the charged optomechanical resonator comprises interrogating the optical cavity using a laser and detecting an output of the cavity.

3. The method of claim 2, wherein detecting the output of the cavity comprises detecting a beat note between light transmitted by the cavity and light obtained from a reference light source.

4. The method of claim 1, wherein sensing the displacement comprises sensing a resonance frequency of the optical cavity and calculating the displacement based at least in part on the sensed resonance frequency.

5. The method of claim 1, further comprising measuring a magnitude of the magnetic field along at least a first direction, wherein the one or more factors further include the measured magnitude of the magnetic field.

6. The method of claim 1, further comprising modulating an amount of charge on the charged optomechanical resonator, such that a first frequency-domain response of the charged optomechanical resonator to the magnetic field is separate in the frequency domain from a second frequency-domain response of the charged optomechanical resonator to any charge-independent forces.

7. The method of claim 6, wherein the charged optomechanical resonator comprises a first electrode of a capacitor, and wherein modulating the amount of charge on the charged optomechanical resonator comprises modulating a voltage of the capacitor.

8. The method of claim 1, wherein the charged optomechanical resonator is a first charged optomechanical resonator, the optical cavity is a first optical cavity, and the velocity is a first velocity component along a first direction, the method further comprising:
sensing a second displacement of a second charged optomechanical resonator disposed in a second optical cavity as the second optical cavity moves through the magnetic field, and determining a second velocity component along a second direction based at least on the sensed second displacement; and
sensing a third displacement of a third charged optomechanical resonator disposed in a third optical cavity as the third optical cavity moves through the magnetic field, and determining a third velocity component along a third direction based at least on the sensed third displacement.

9. The method of claim 1, further comprising navigating a mobile platform, wherein the optical cavity is carried on the mobile platform, and wherein navigating the mobile platform comprises:
estimating a location of the mobile platform based at least on the determined velocity, a direction of movement of the mobile platform, a previous known location of the mobile platform at a previous point in time, and an amount of time elapsed since the previous point in time.

10. A system for sensing velocity, the system comprising:
a first optical cavity comprising a first optomechanical resonator, the first optomechanical resonator having an electrical charge;
an optical measurement system configured to sense an optical output of the first optical cavity; and
processing logic in communication with the optical measurement system, wherein the processing logic is configured to determine, based on the sensed optical output of the first optical cavity, a displacement of the first optomechanical resonator by a magnetic field through which the first optical cavity is traveling.

11. The system of claim 10, wherein the first optomechanical resonator comprises a membrane.

12. The system of claim 11, wherein the membrane comprises a trampoline resonator.

13. The system of claim 10, wherein the first optical cavity comprises a Fabry-Perot cavity.

14. The system of claim 10, wherein the optical measurement system comprises a laser locked to the first optical cavity and a detection system configured to sense a frequency shift in the optical output of the first optical cavity, and wherein the processing logic is configured to determine the displacement of the first optomechanical resonator based on the sensed frequency shift.

15. The system of claim 10, further comprising:
a second optical cavity comprising a second optomechanical resonator;
a third optical cavity comprising a third optomechanical resonator; and
wherein the first, second, and third optical cavities are oriented orthogonally to one another.

16. A system for sensing velocity, the system comprising:
a Lorentz force sensor comprising a charged object, wherein the Lorentz force sensor is configured to sense a Lorentz force experienced by the charged object;
a magnetometer configured to sense a magnetic field at a present location of the Lorentz force sensor; and
processing logic configured to determine, based on the sensed Lorentz force and the sensed magnetic field, a velocity of the charged object through the magnetic field.

17. The system of claim 16, wherein the Lorentz force sensor comprises a pair of mirrors defining an optical cavity, the optical cavity having a cavity frequency, and wherein the charged object comprises a charged optomechanical resonator disposed between the pair of mirrors.

18. The system of claim 17, wherein the processing logic is configured to determine the velocity of the charged object through the magnetic field based on a shift in the cavity frequency.

19. The system of claim 17, wherein the charged optomechanical resonator comprises a membrane.

20. The system of claim 19, wherein the membrane comprises a body portion and a peripheral portion, the peripheral portion is coated in metal and forms a first electrode of a capacitor, and a second electrode of the capacitor is disposed adjacent the membrane.
